(19) United States
(12) Patent Application Publication
(10) Pub. No.: US 2003/0145661 A1
(43) Pub. Date: Aug. 7, 2003

(54) Gas parameter sensing apparatus and method

(76) Inventor: Thomas Taranto, Baldwinsville, NY (US)

Correspondence Address: HANCOCK & ESTABROOK, LLP, Tower I, 1500 MONY, PO Box 4976, Syracuse, NY, 13221-4976, US

(21) Appl. No.: 10/068,582

(22) Filed: Feb. 6, 2002

(51) Int. Cl. G01F 1/46

(52) U.S. Cl. 73/861.65

(57) ABSTRACT

Apparatus for measuring or detecting one or more parameters of a gas, such as compressed air, in a line through which the gas is flowing by a sensing portion of an elongated wand which is axially inserted through piping attached to the line and advanced into the line radially thereof. The apparatus of the present invention, and the method of its use, avoid the problem of the wand being forcibly ejected from the piping upon removal thereof by providing an element having a diameter larger than the passageway in the packing gland through which the wand is inserted. The element is attached to an elongated tubing portion of the wand after insertion of the distal end of the tubing through the packing gland. The element may be one end of the probe containing the sensing elements, a plug closing the distal end of the tubing, or an additional, larger diameter of the section of tubing. Mass flow rate may be measured by conventional sensing elements, and/or the direction of flow may be indicated by dividing the sensing portion into two mutually isolated compartments, communicating through respective openings on diametrically opposite sides of the sensing portion with the interior of the line. The openings are oriented axially of the line so that the pressure in the two compartments will correspond to total and static pressure, respectively. Since total pressure is always higher than static pressure, direction of flow may be determined by a differential pressure device to which pressures in the compartments are respectively communicated. The invention also provides a method for shortening the axial length of the wand in the field, thus solving another problem associated with prior art apparatus of this type.

### BACKGROUND OF THE INVENTION

The present invention relates to apparatus for measuring parameters of gas flow through an enclosed conduit and to methods of employing such apparatus. More specifically, the apparatus of the invention is of a type which may be used to determine one or more of the mass flow rate, pressure and direction of flow of compressed air, or the like, through a line, and the method of the invention involves manipulation or field modification of such apparatus to perform the intended function(s) or to permit its use in physically confined areas.

Although not limited solely to use in applications involving compressed air flow, such applications are certainly the major contemplated area of employment of the invention. Consequently, the ensuing description will be directed to a discussion of the invention in the context of an industrial compressed air system. It is a common practice to use compressed air to provide energy for many industrial applications with compressors operating at several locations and lines connecting the compressors to the various production operations throughout an industrial facility. Since compressed air is certainly not a cheap source of industrial energy, it becomes increasingly important for the user to monitor parameters associated with the generation and transmission of compressed air energy in order to control its use most economically.

In measurement of many parameters of gas flowing through a conduit, it is common practice to insert a probe radially into the conduit through a wall thereof. The probe may carry, for example, thermal mass flow sensing elements such as resistance temperature detectors (RTDs) to be positioned at or near the axial centerline of the conduit or air line. The sensing elements are mounted to the distal end of a tube through which wires pass to connect the elements to appropriate measurement electronics. The tube is of predetermined length sufficient to permit use of the probe in air lines of a maximum anticipated diameter. The probe may be inserted and withdrawn from the air line while air at, e.g., 100-150 psi is flowing therethrough by inserting the tube through a packing gland and isolation ball valve. When the tube is withdrawn, the distal end of the probe must clear the ball valve in order to avoid possible damage by attempting to close the valve while a portion of the probe is positioned therein. It is also necessary to avoid withdrawing the tube and probe past the packing gland to prevent release of high-pressure air. Since the pipes through which the tube is axially moved are opaque, the operation cannot be visually monitored and accidents are not uncommon.

It is often desirable to measure the pressure of the air flowing through the line. Although the prior art provides a number of examples of pressure measurement in such applications, attempts to decrease the cost of the measurement system are accompanied by degradation of accuracy. A third parameter which is sometimes useful to detect is the direction of flow through the line. Again, prior art apparatus for detecting flow direction is expensive or otherwise unsuited for employment in conjunction with RTD probes.

It is an object of the present invention to provide apparatus for measurement or detection of one or more parameters of a gas flowing through a conduit which involve insertion and withdrawal of a probe tube radially of the conduit through a packing gland and isolation ball valve wherein the tube may easily be withdrawn to the proper extent without visual observation or time-consuming external measurements.

Another object is to provide an air/gas sensor probe mounted at the distal end of an elongated tube wherein the tube may quickly and easily be shortened in the field when the physical working space is too small for use of the probe with the original tube length.

A further object is to provide a method for field modification of air/gas flow sensing apparatus to enhance the usefulness thereof.

Still another object is to provide novel and improved apparatus and method of use thereof to detect direction of air/gas flow within a conduit.

A still further object is to provide novel and improved apparatus for sensing both mass flow and pressure sensing through a single pipeline connection in a compressed air/gas supply system.

Other object will in part be obvious and will in part appear hereinafter.

### SUMMARY OF THE INVENTION

In accordance with the foregoing objects, the invention includes a probe for radial insertion through an opening in the wall of a conduit such as a compressed air supply line for sensing one or more parameters of the gas flowing within the line. The probe is integral with or mounted to the distal end of an elongated tube and may carry sensing elements of the RTD type for generating electrical signals having values from which the mass flow rate of the air may be extrapolated, as is common in the prior art. Wires from the probe elements pass through the tube for connection to the sensing electronics. The tube passes through a linear section, or several connected sections, of hollow pipe including a packing gland and isolation ball valve. Rather than directly connecting or integrally forming the tube and the probe, a connector tube is soldered at its proximal end to the distal end of the tube and a nipple threadedly connects the distal end of the connector tube to the probe. The connector tube is of larger diameter than the passageway in the housing leading to the packing gland. Thus, as the tube is slid axially through the packing gland during withdrawal of the probe from the air line, the proximal end of the connector tube contacts the gland housing around the entry to the passageway, preventing further withdrawal of the tube. This ensures that the tube will not be withdrawn completely through the packing gland while the ball valve is open, thus forcibly ejecting the probe and releasing high-pressure air. The distance from the distal end of the probe to the proximal end of the connector tube is less than the distance from the ball valve to the entry of the gland housing passageway, thus ensuring that the ball valve may be closed without contacting and potentially damaging the probe when the end of the connector tube contacts the gland housing.

Commercially available probes for insertion into air lines come equipped with a tube of predetermined length. The tube is permanently connected at its proximal end to a housing which contains the sensing electronics. The length of the tube, including the probe, is selected so that the apparatus may be used in conjunction with air lines up to a maximum contemplated diameter. It sometimes happens that physical barriers, e.g., a wall or another air line, prevent positioning the tube for axial insertion through a preformed opening in a line because the barrier is closer to the opening than the length of the tube. In such cases, if apparatus having a shorter tube is not immediately available, sensing cannot be performed at that location. In one aspect of the present invention, the tube is connected to a threaded coupling on the sensor electronics housing by a ferrule including a captured nut. The wires which extend through the tube are disconnected from the terminal block within the housing and the nut is removed from the threaded coupling, permitting the wires to be drawn out of the housing through the coupling. The tube is then cut to the desired length, taking care not to cut the wires. The severed portion of the tube, with the ferrule attached, is slid over the ends of the wires and discarded. A new ferrule is then placed on the newly cut proximal end of the tube and installed on the threaded connector on the housing. The wires are reconnected to the proper terminals and excess wire coiled within the housing.

In another aspect of the invention, measurement of pressure within the line is provided by forming a hole in the connecting tube so that pressure inside the tube is equal to pressure in the air line. The wires from the probe elements pass through an epoxy plug, whereby there is no direct communication from the interior of the probe to the interior of the tube. However, the interior of the air line communicates with the pipe which connects the isolation ball valve to the air line and wherein the connector tube is positioned through the opening in the wall of the air line. Thus, forming one or more holes in the connecting tube and communicating the pressure therein to a pressure transducer effectively measures pressure in the air line.

In still another form, the invention provides a simple yet effective means of detecting the direction of flow through the line. For this purpose, two holes are formed in the connecting tube, axially spaced along its length and on diametrically opposite sides. An epoxy plug, through which both the wires from the probe sensors and an open, small diameter tube pass, separates the interior of the connecting tube into two compartments with which the two holes respectively communicate. When it is desired to detect the direction of air flow, the tube is advanced into the air line until the connecting tube is positioned within the air line and rotationally oriented with the openings in the connecting tube facing axially of the air line. In this manner, one of the openings will be facing in the upstream direction of air flow, whereby pressure in the compartment with which this opening communicates will reflect total pressure within the air line, and the other opening will be facing in the downstream direction with the pressure in the compartment with which it communicates reflecting static pressure. Pressure in the inboard (nearest to center of air line) compartment is communicated through the small diameter tube to one side of a diaphragm or other suitable means for detecting pressure differential, and pressure in the outboard compartment is communicated directly through the tube to the other side. The air flow direction is established by the fact that the pressure will be higher in the compartment with the hole facing in the upstream direction than in the compartment with the hole facing downstream; the comparison is, in effect, a comparison of total (higher) and static (lower) pressure in the air line.

The foregoing and other features of construction and operation of the invention will be more readily understood and fully appreciated from the following detailed disclosure, taken in conjunction with the accompanying drawings, wherein the embodiments discussed in the foregoing summary, as well as others, will be shown and described.

### BRIEF DESCRIPTION OF THE DRAWINGS

FIG. 1 is a perspective view of a section of a typical industrial compressed air line with piping attached to accommodate radial insertion into the line of probe apparatus for sensing parameters of the air flow within the line;

FIG. 2 is a fragmentary, elevational, sectional view of an example of prior art sensing apparatus including a probe and elongated tube;

FIG. 3 is a fragmentary, elevational view, in section, of a first embodiment of sensing apparatus of the present invention;

FIG. 4 is an elevational view, in section, of the apparatus rotated 90° about its central axis from the position of FIG. 3;

FIG. 5 is an elevational view, in section, of the apparatus of FIGS. 3 and 4 mounted in an air line and associated piping;

FIG. 6 is a fragmentary, elevational view, in section, of a second embodiment of sensing apparatus of the present invention;

FIG. 7 is an elevational view of the apparatus rotated 90° about its central axis from the position of FIG. 5;

FIGS. 8 and 9 are fragmentary, elevational, sectional views of an air line and piping with the sensing apparatus of FIGS. 5 and 6 inserted therein to three different positions;

FIG. 10 is a fragmentary, elevational, sectional view of an air line and piping with modified sensing apparatus inserted therein;

FIG. 10A is a portion of FIG. 10 with the illustrated elements rotated 90°;

FIG. 11 is a partly diagrammatic illustration of the apparatus showing the manner in which pressure sensing is performed; and

FIG. 12 is a plan view of the housing, with cover removed, containing the sensing electronics for the apparatus of the invention, with a fragment of the tube through which wires extend from the electronics to the probe.

### DETAILED DESCRIPTION

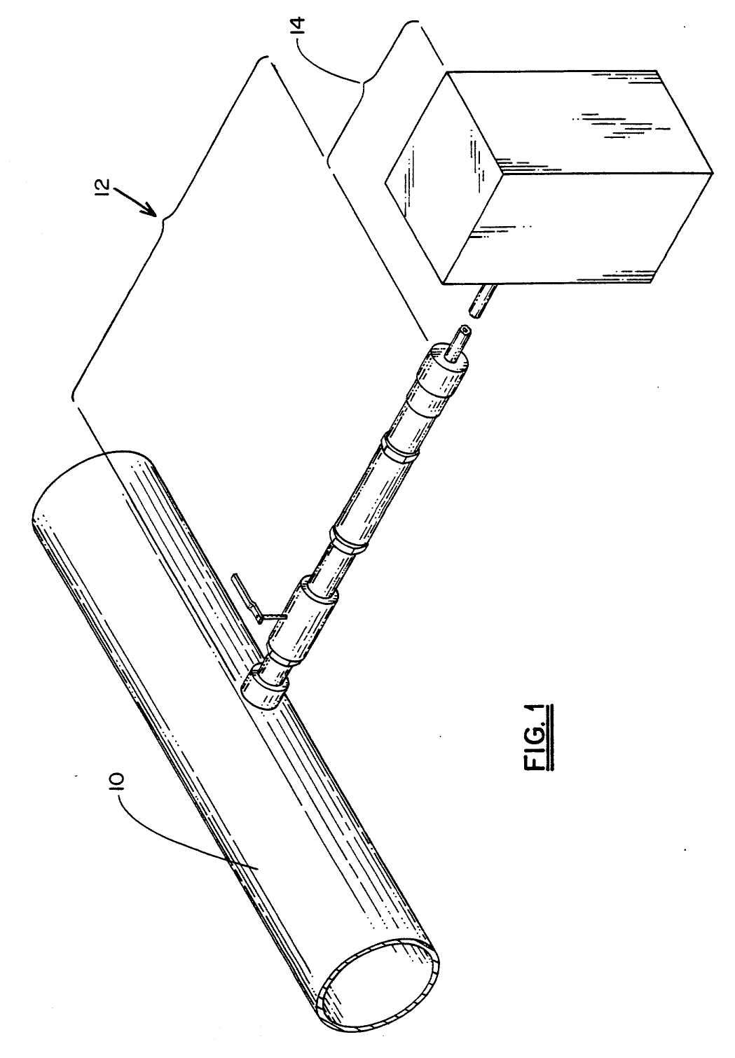

Referring now to the drawings, in FIG. 1 is shown a section of a typical industrial compressed air line 10 for conducting air from a compressor to a position where the energy is used to perform production operations. Piping 12, including individual elements described later herein, such as a packing gland and isolation ball valve, is affixed to line 10 and extends radially outwardly therefrom with the interiors of the line and the piping communicating through an opening (identified later) in the wall of line 10. Piping 12, including all individual elements thereof and the manner and purpose of its connection to line 10, i.e., to permit selective insertion into and removal from the pressurized line of sensing apparatus for measuring certain parameters of the air flow, is entirely conventional. Sensing apparatus 14 is shown in FIG. 1 ready for insertion through piping 12 into line 10.

A common means of measuring mass flow of gas through an enclosed line or passageway is through a pair of resistance temperature detector (RTD) elements mounted in a probe and positioned directly in the gas stream, preferably at or near the axial center of the line. An example of prior art probe 16 with RTD elements 18 mounted therein, for exposure to gas flow through an opening in the probe, is shown in FIG. 2. Two wires connect each RTD element with terminal blocks within housing 20 to transmit electrical signals from the RTD elements to the sensing electronics. Wires 22 extend through epoxy plug 24 and through elongated tube 26 which is threadedly connected to probe 16. It will be noted that probe 16 and tube 26 are of equal diameters, which is standard practice in prior art sensing apparatus 14. When tube 26 is withdrawn from piping 12 and probe 16 is within the piping prior to closing the isolation ball valve, pressurized air within line 10 acts upon the end of the probe, tending to forcibly eject the probe and tube from the piping. Precautions must be taken to ensure that such ejection does not occur.

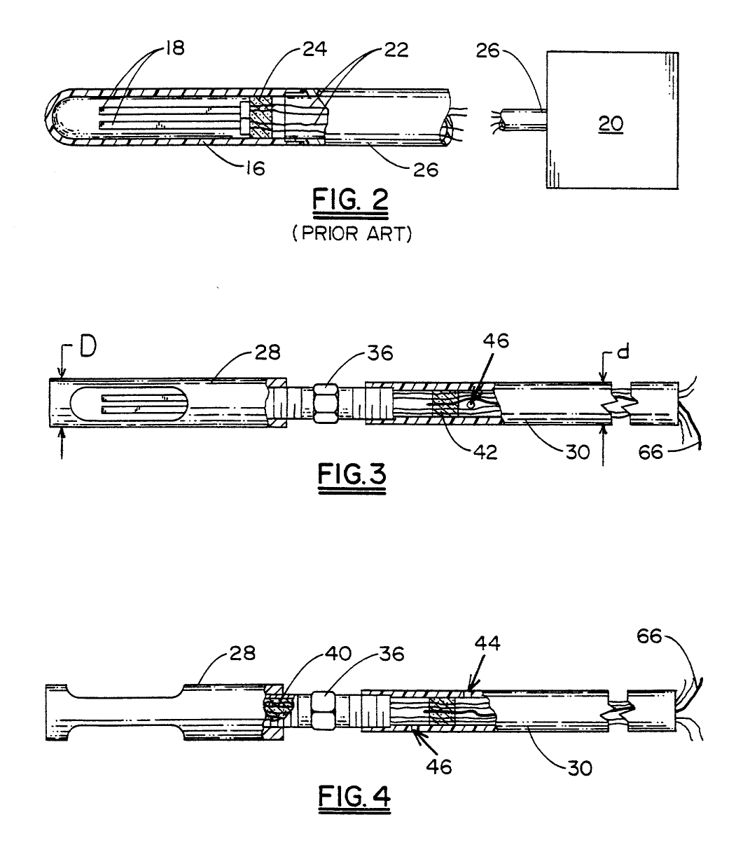

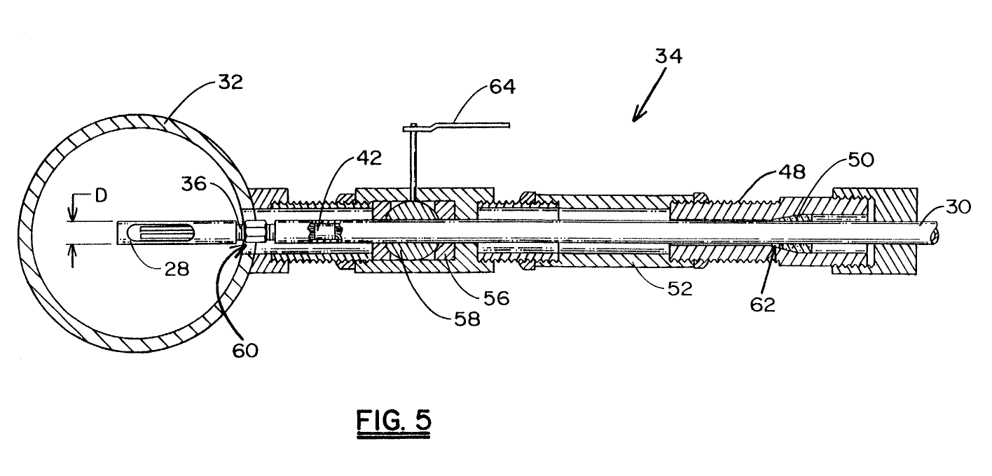

Probe 28 and elongated tube 30, representing a first embodiment of the present invention, are shown in FIGS. 3 and 4 in 90° rotational orientations and in FIG. 5 mounted within air line 32 and associated piping 34. Probe 28 has an outer diameter D and is connected by threaded nipple 36 to tube 30 which has an outer diameter d, smaller than diameter D. Wires (not shown in FIG. 5) extend from RTD elements 38 through epoxy plug 40 in nipple 36, epoxy plug 42 in tube 30 and through the tube to the sensing electronics in the same manner as wires 22 of the prior art example. Through holes 44 and 46 are formed in tube 30 on axially opposite sides of plug 42 and on diametrically opposite sides of tube 30, i.e., at 180° from one another. Tube 30 extends through piping section 48 which holds packing gland 50, coupling 52, nipple 54 and piping section 56 holding isolation ball valve 58 to connect to nipple 36 which extends through opening 60 in air line 32 to support probe 28 therein.

The opening in packing gland 50 is slightly smaller than diameter d, so that the somewhat resilient material of the gland is in sealing engagement with tube 30 and permits both rotational and axial movement of the tube through the gland. Passageway 62 in piping section 48 leading to packing gland 50 has a diameter larger than d and smaller than D. When assembling the elements, tube 30 must be advanced through packing gland 50 prior to threading probe 28 onto nipple 36 and prior to connecting piping section 48 to coupling 52. The inside diameters of nipple 54 and piping section 56, as well as opening 60 in air line 34 and the opening in ball valve 58, are larger than D. Thus, probe 28 may be advanced through tubing 34 and into air line 32, but may be withdrawn only until the outboard or proximal end of the probe contacts piping section 48 at the entrance to passageway 62. In order to gain access to probe 28, e.g., for inspection or replacement, piping section 48 must be removed. This arrangement ensures that probe 28 is captured within piping 34 and cannot be forcibly ejected by the pressure within line 32 prior to closing ball valve 58 by turning handle 64 after withdrawal of the probe past the valve. Furthermore, the net force exerted by the air pressure will be upon the area of a circle having a diameter equal to that of tube 30 rather than the larger diameter of probe 28.

With the apparatus in the position of FIG. 5, the interior of line 32 communicates with the interior of piping 34, from line 32 to packing gland 50, through opening 60; line 32 also communicates with the interior of tube 30 through each of openings 44 and 46. Thus, measurement of the pressure within tube 30 on either side of plug 42 will provide an accurate representation of the pressure within air line 32. As explained later, the direction of air flow within line 32 may also be determined with the apparatus of FIGS. 3-5. The compartment on the inboard side of plug 42 communicates with one side of a suitable pressure differential indicating device through small diameter tube 66 (shown in FIG. 4 but not in 3 or 5) while the compartment on the outboard side communicates directly with the other side of such device. By advancing tube 30 through piping 34 until openings 44 and 46 are both positioned within line 32 and rotationally orienting the tube with the openings aligned with the longitudinal axis of the line, one of the openings will be oriented in the upstream direction of air flow and the other in the downstream direction. The pressure differential device will indicate which chamber has the higher pressure. In this manner, as explained in greater detail later, the direction of air flow through line 34 may be determined.

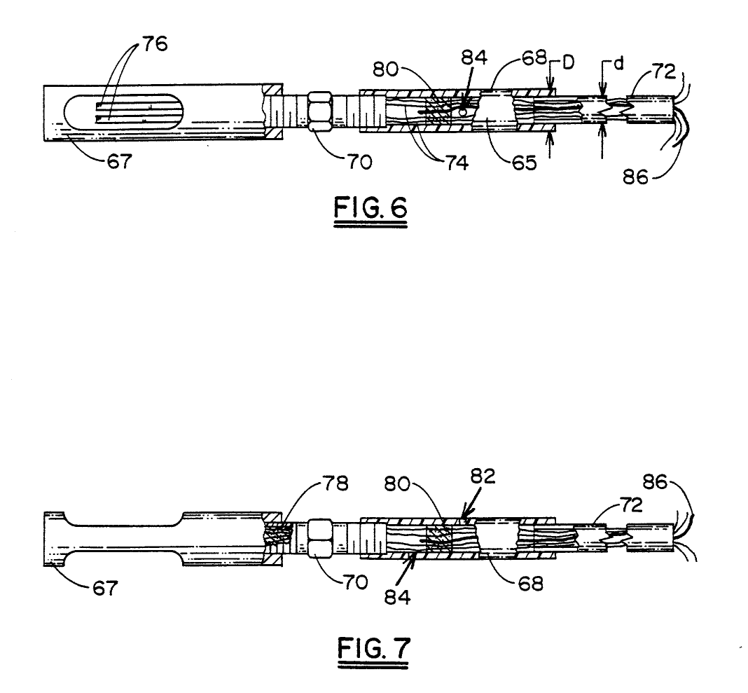

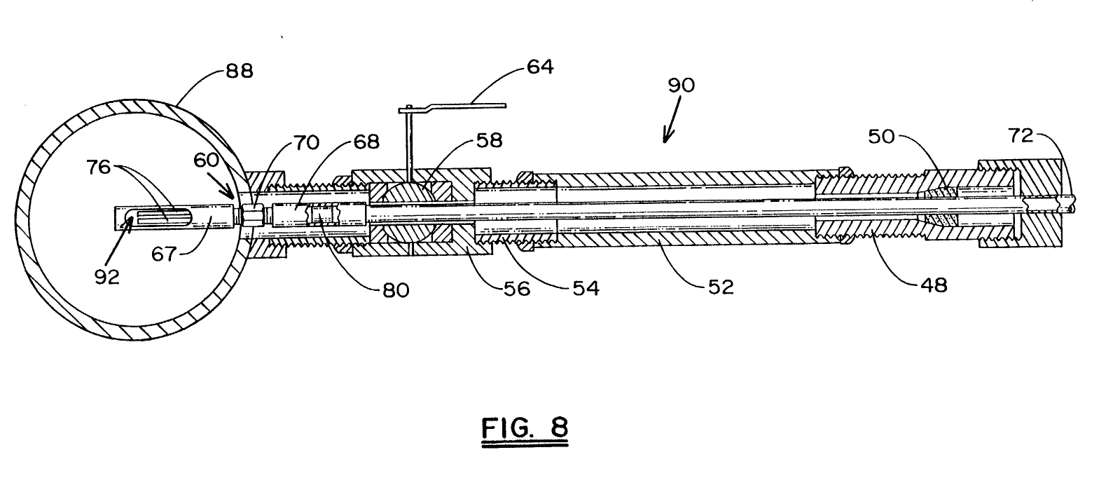

Turning now to FIGS. 6 and 7, another embodiment of sensing apparatus is shown. Probe 67 is threadedly connected to connector tube 68, having diameter D, by nipple 70. Tube 72, having diameter d, is connected to the other end of tube 68, preferably by silver soldering the two in permanent engagement. Wires 74 connect RTD elements 76 to the sensor electronics, passing through epoxy plugs 78 and 80 in nipple 70 and connector tube 68, respectively, and through tube 72 to the electronic controls. Through openings 82 and 84 are formed in connector tube 68 spaced axially on opposite sides of plug 80 and on diametrically opposite sides of tube 68. The chamber between plugs 78 and 80 communicates through small diameter tube 86 with one side of a pressure differential responsive device, as described later.

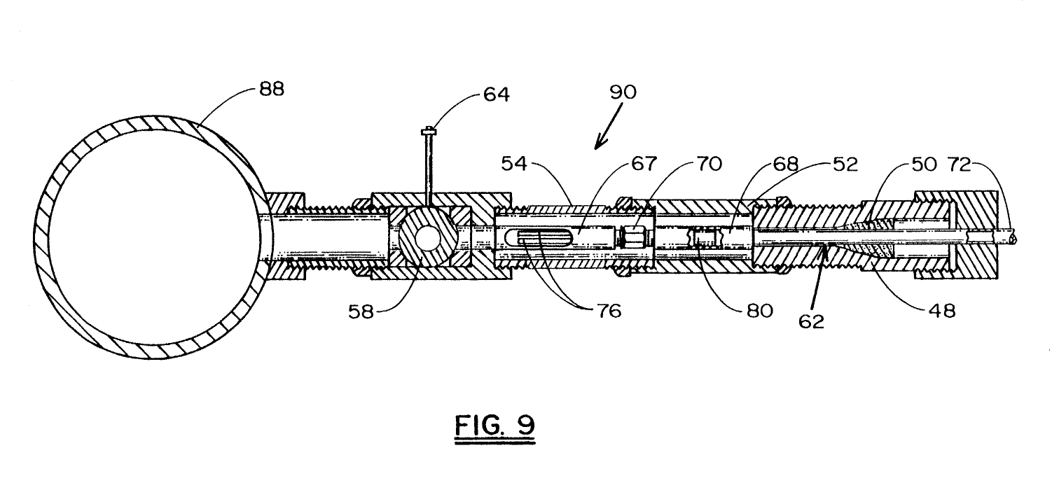

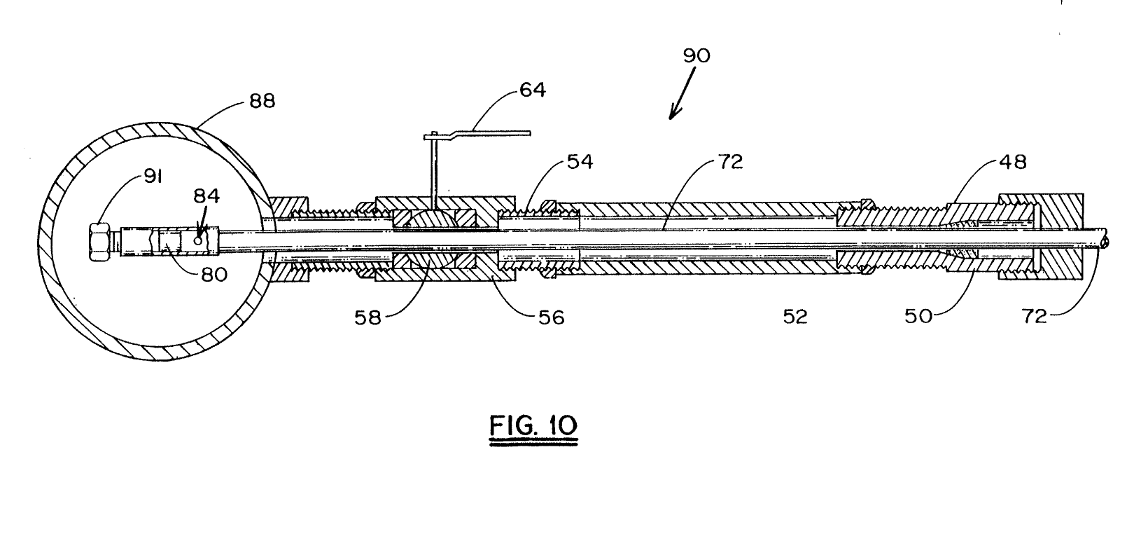

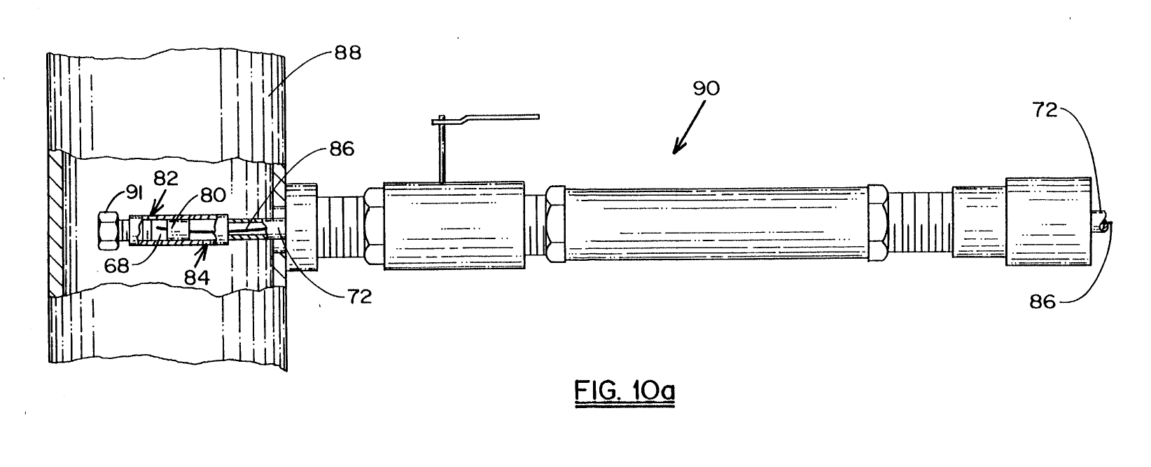

The apparatus of FIGS. 6 and 7 is shown in connection with air line 88 and piping 90 in FIGS. 8 and 9. Piping 90 may correspond essentially to piping 34 and the same reference numerals are used to denote corresponding sections of the piping in the two embodiments of sensing apparatus. However, the distance between ball valve 58 and piping section 48 is greater in the FIGS. 8-9 embodiment by increasing the axial length of coupling 52, nipple 54, or both. The apparatus is shown in FIG. 8 with probe 67 positioned within air line 88, the distal ends of RTD elements 76 being approximately at the longitudinal centerline of line 88 and opening 92 in probe 66, through which elements 76 are exposed, oriented in the upstream direction to measure mass flow volume. Also, pressure within line 88 may be measured by a transducer communicating with the line through either of openings 82 and 84.

The apparatus may be withdrawn from the position of FIG. 8 to that of FIG. 9, where further movement is prevented by contact of the outboard or proximal end of connector tube 68 with piping section 48 at the entrance to passageway 62. The combined length of sections 52 and 54 is greater than the length between the outboard (proximal) end of connector tube 68 and the distal end of probe 66, ensuring that ball valve 58 may be closed without contacting and possibly damaging the probe. Sections of piping 90 outboard of ball valve 58 may be safely removed after the ball valve is closed. In order to remove the probe apparatus from association with piping 90 and air line 88, piping section 48 is uncoupled from section 52. Section 48 remains on tube 72, captured between connector tube 68 at one end and the control box to which the other end of tube 68 is connected. If piping section 48 is to be removed from tube 72, the latter is uncoupled from the control box and wires 74 are disconnected from the terminal block therein, as explained later in connection with FIG. 12.

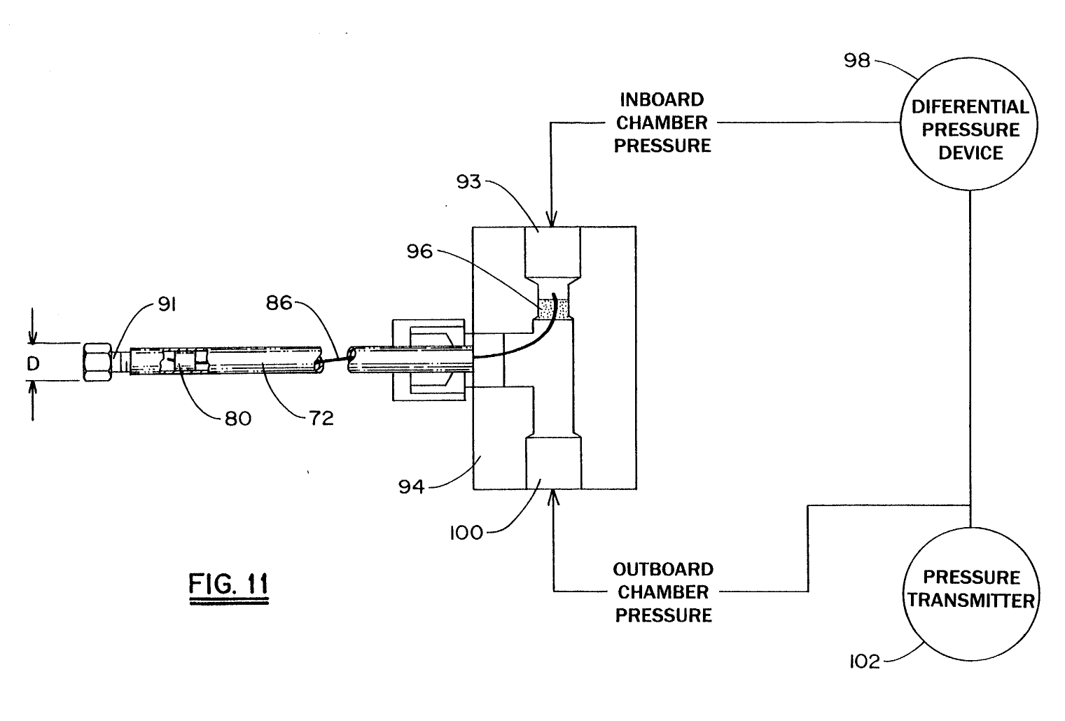

In order to determine the direction of air flow within line 88, the sensing apparatus is advanced to the position of FIG. 10 with one of openings 82 and 84 facing in the upstream and the other in the downstream direction, as previously discussed and as shown in FIG. 10A. In some applications, flow rate measurement devices may already be installed at appropriate positions in the air line, or flow rate measurement by removably inserted probe apparatus may be unnecessary for other reasons. Although pressure and flow direction may be determined using the apparatus of either of the two disclosed embodiments, the probe with RTD detectors is unnecessary if there is no requirement to measure flow rate. Therefore, the probe and its associated wiring and controls have been eliminated in the FIG. 10 illustration and the inboard end of tube 68 is closed by plug 91. Of course, through openings 82 and 84, as well as plug 80, may be provided directly in tube 72, if desired, eliminating connecting tube 68 as well, although it is preferred in that case that some portion of plug 91 be of diameter D in order to preserve the feature of preventing forcible ejection of tube 72 through packing gland 50.

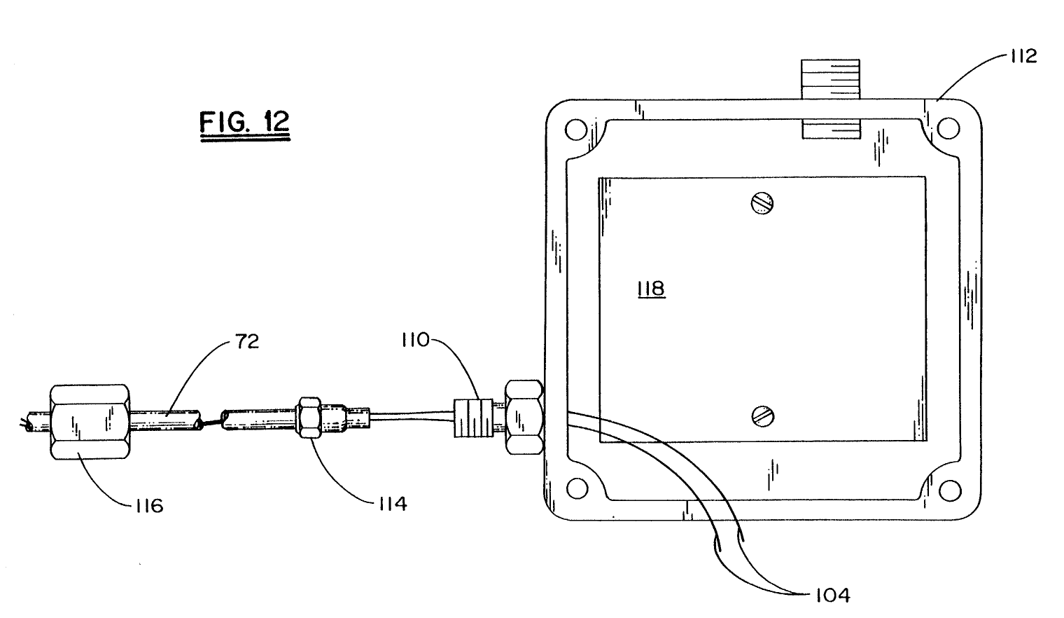

FIG. 11 illustrates the preferred connection of the elements for pressure and flow direction sensing. The chamber between epoxy plugs 91 and 80, communicates through small diameter tube 86 with chamber 93 of piping T-section 94; chamber 93 is isolated by epoxy plug 96 from the outboard portion of tube 72.and outboard chamber pressure is thus communicated to one side of differential pressure indicator 98. The outboard chamber communicates directly, through T-section branch 100, with the other side of indicator 98 and with pressure transmitter 102. Thus, with the elements in the position of FIG. 10, the direction of air flow in line 88 is apparent from the pressure readings. If the inboard chamber registers a pressure higher than that of the outboard chamber, then it is opening 82 which is facing the upstream direction of air flow, and vice versa. It is necessary, of course, to provide some means of indicating, e.g., visually observable indicia on a portion of the apparatus which does not enter the piping, the rotational orientation of the probe/tube so that the orientation of openings 82 and 84 is apparent to the operator. It should be noted that accurate measurements of the pressure in the inboard and outboard chambers are not necessary in order to determine direction of air flow, the only requirement being an indication of which chamber has a pressure higher than the other. Accordingly, simple and cheap pressure differential indicating means such as a flip-flop diaphragm may be used as element 98, although more expensive means such as a differential pressure transmitter may be used if conditions require.

Another aspect of the invention. is illustrated in FIG. 12. Sensing apparatus such as that of the present invention is supplied by the manufacturer with a predetermined length of probe/tube. That is, the tube through which the wires pass is permanently connected at its proximal end to the housing for the sensor electronics and its length cannot normally be altered in the field. In some installations, the end of the piping through which the probe/tube is inserted is too close to a wall, another air line, or other immovable obstruction to permit axial alignment of the sensing apparatus with the piping for insertion purposes. In a preferred form of the present invention tube 72 is connected to threaded fitting 110 on housing 112 for the sensor electronics through ferrule 114. If the length of the probe/tube causes interference with a physical barrier in axial alignment with the piping, preventing insertion of the probe/tube into the piping and air line, nut 116 may be disengaged from fitting 110, as shown, thereby releasing the coupling of tube 72 and housing 112. Wires 104 are removed from their respective connections to terminal block 118 and pulled through fitting 112. Tube 72 is then cut to the desired length and the severed portion is pulled over the ends of wires 104 and discarded. A new ferrule is installed on the newly formed proximal end of the tube and nut 116 is threadedly connected to fitting 110. Wires 104 are reconnected to their respective terminals and the apparatus is again ready for use with a shorter tube. It is important that wires 104 remain at their original length, i.e., the wires must not be cut during this operation, in order not to affect sensing accuracy.

From the foregoing it will be seen that the sensing apparatus of the invention provides some or all of a number of advantages over prior art devices of the same general type, i.e., the type wherein an elongated wand is inserted radially into the line through which gas is flowing for measurement or indication of certain parameters. In the prior art, and in some embodiments of the invention, the wand includes a probe or sensing element and a hollow tube, whereas in other embodiments of the present invention the wand may be comprised of only the tube with a plug closing its distal end, or of the tube and a larger diameter tube connected to a probe or plug. In any case, the term “wand” is used to denote the totality of the elongated structure which is inserted through the piping to extend into the gas line. Structural features of the wand of the present invention effectively prevent the wand from being forcibly ejected from the piping by pressure withing the air line. Also, the pressure within the air line may conveniently be measured simultaneously with mass air flow measurement. A further feature permits use of the apparatus to determine the direction of air flow in the line. The apparatus of the invention is also adapted for field alteration of the axial length of the wand.

What is claimed is:

1. Apparatus for sensing one or more parameters of a gas flowing through a conduit following insertion of portions of said apparatus radially into said conduit through a predetermined length of piping connected to said conduit at one end and open at the other end to receive said apparatus, said piping including a first section containing an isolation ball valve and a second section containing a packing gland having a passageway of predetermined diameter, said ball valve and said packing gland being spaced from one another by a first, predetermined distance, said apparatus comprising:
a) an elongated wand having proximal and distal ends, a central axis, an axial length greater than said predetermined length and a tubular portion having a uniform diameter substantially equal to said predetermined diameter for sliding, axial movement of said tubular portion through said passageway; and
b) a member fixed with respect to said wand and extending radially outwardly therefrom past the cylindrical plane of said tubular portion, thereby preventing passage of said member through said packing gland, the distance between said member and the distal end of said wand being less than the distance from said ball valve to said packing gland.

2. The apparatus of claim 1 wherein said wand includes said tubular portion and a probe portion forming said distal end of said wand.

3. The apparatus of claim 2 wherein said probe carries sensing elements providing an electrical signal commensurate with mass flow rate of a gas to which said elements are exposed.

4. The apparatus of claim 3 wherein said member comprises an integral portion of said probe.

5. The apparatus of claim 4 and further including a nipple connecting said probe to said tubular portion.

6. The apparatus of claim 4 and further including a nipple and a connecting tube having a diameter larger than said predetermined diameter, said connecting tube connecting said tubular portion to said nipple and said nipple connecting said connecting tube to said probe.

7. The apparatus of claim 1 wherein said wand comprises said tubular portion and a plug forming said distal end of said wand.

8. The apparatus of claim 7 wherein said member comprises a portion of said plug.

9. The apparatus of claim 7 and further including a connecting tube having one end connected to said tubular portion and the other end closed by said plug.

10. The apparatus of claim 9 wherein said connecting tube has a diameter larger than said predetermined diameter and said member comprises said one end of said connecting tube.

11. Apparatus for detecting the direction of flow of a gas within an enclosed, elongated line, said apparatus comprising:
a) a hollow member having first and second, mutually isolated, internal compartments;
b) first and second passages through which said first and second compartments, respectively, communicate with the exterior of said member;
c) a differential pressure detecting device for indicating which of two pressures communicated to said device is higher than the other; and
d) third and fourth passages through which the pressures within said first and second compartments, respectively, are communicated to said device.

12. The apparatus of claim 11 wherein said member is tubular, having a linear central axis and is divided into said first and second compartments by an internal wall transverse to said axis.

13. The apparatus of claim 11 wherein said first and second passages comprise through openings in said tubular member on opposite sides of said internal wall.

14. The apparatus of claim 13 wherein said openings are on diametrically opposite sides of said tubular member.

15. The apparatus of claim 14 wherein said third passage comprises a tube having a first, open end disposed within said first compartment and a second end communicating with a portion of said differential pressure detecting device.

16. The apparatus of claim 15 wherein said differential pressure detecting device is a flip-flop diaphragm having opposite sides exposed to pressure in said first and second compartments, respectively.

17. The method of sensing one or more parameters of a gas flowing through an elongated, enclosed line, said method comprising:
a) forming an opening in a wall of said line;
b) attaching to said line in covering relation to said opening a length of piping having a linear axis extending radially of said line, said piping comprising a plurality of releasably connected sections including a first section containing an isolation ball valve and a second section containing a packing gland having a first passageway of first diameter, said piping between said second section and said line having a second passageway of not less than a second diameter, larger than said first diameter, said packing gland being spaced along said axis by a first distance from said ball valve on the opposite side of said ball valve from said line;
c) disconnecting said second section from said piping;
d) axially advancing through said passageway the distal end of a tubular member having an outer diameter substantially equal to said first diameter;
e) attaching to said tubular member an element extending radially outwardly from the plane of said outer diameter to provide a cross dimension greater than said first diameter and less than said second diameter, to form an elongated wand comprising at least said tubular member, said element and a sensing portion, said element being on the same side of said second piping section as said distal end of said tubular member, whereby said element prevents axially retracting movement of said wand through said passageway past said element;
f) connecting said second section to said piping;
g) opening said ball valve;
h) axially advancing said wand through said piping until said sensing portion is positioned within said line;
i) sensing said at least one parameter;
j) axially retracting said wand through said piping until said distal end is positioned between said ball valve and said first passageway; and
k) closing said ball valve.

18. The method of claim 17 wherein said sensing portion comprises a probe for measuring mass air flow and said element comprises an integral part of said probe.

19. The method of claim 17 wherein said element is threadedly attached to said tubular member.

20. The method of claim 17 and including the further step of again disconnecting said second section from said piping following closing said ball valve.

21. The method of shortening the axial length of an elongated wand having a probe carrying sensing elements for generating electrical signals commensurate with mass flow of a gas to which said elements are exposed, and a hollow tube having a distal end connected to said probe and a proximal end connected to a housing containing a terminal block for connection of wires extending from said elements through said hollow tube and into said housing through an opening communicating with the interior of said tube, said method comprising:
a) affixing to said housing a threaded fitting having a through passageway communicating with said opening;
b) slidably inserting on said proximal end of said tube a nut having threads matable with said threaded fitting;
c) affixing to said proximal end of said tube a ferrule;
d) passing said wires from said tube through said threaded fitting and opening, into said housing and connecting said wires to said terminal block;
e) threadedly engaging said nut with said threaded fitting to urge said ferrule into engagement with said threaded fitting; and thereafter:
f) disconnecting said wires from said terminal block;
g) disconnecting said nut from said threaded fitting, removing said ferrule from engagement with said threaded fitting and pulling said wires out of said housing through said opening and threaded fitting;
h) severing a portion of said tube to form a new proximal end;
i) pulling said severed portion and its attached ferrule over the ends of said wires while leaving said nut slidingly engaged on said tube;
j) affixing a new ferrule to said new proximal end;
k) passing said wires from said tube through said threaded fitting and opening, into said housing and reconnecting said wires to said terminal block; and
l) threadedly engaging said nut with said threaded fitting to urge said new ferrule into engagement with said threaded fitting.
